(19) United States
(12) Patent Application Publication
(10) Pub. No.: US 2024/0328775 A1
(43) Pub. Date: Oct. 3, 2024

(54) METHOD FOR MOTOR VEHICLES FOR DETECTING THE HEIGHT OF RAISED OBJECTS

(71) Applicant: ROBERT BOSCH GMBH, Stuttgant (DE)

(72) Inventors: Peter Lakatos, Nötincs (HU); Peter Pozsegovics, Budapest (HU)

(21) Appl. No.: 18/579,174

(22) PCT Filed: Jul. 7, 2022
(86) PCT No.: PCT/EP2022/068851

§ 371 Date: Jan. 12, 2024

(30) Foreign Application Priority Data
Jul. 22, 2021 (DE) 10 2021 207 834.6

(51) Int. Cl. G01B 11/02; B60R 1/22; H04N 7/18

(52) U.S. Cl. CPC G01B 11/028; B60R 1/22; H04N 7/183

(57) ABSTRACT

A method for motor vehicles for detecting the height of raised objects using a camera. The method includes: ascertaining object edge portions of the objects in the at least two items of image information; projecting the object edge portions of the objects from the camera onto a base which is calibrated for the camera; assigning the object edge portions to different objects and ascertaining a common object edge line; ascertaining lines of sight between the camera and the object edge line projected onto the base in at least two positions; ascertaining a point of intersection of the at least two lines of sight of the same objects in the same plane; and determining a height of the point of intersection above the calibrated base of the respective object.

### FIELD

The present invention relates to a method for motor vehicles for detecting the height of raised objects. The present invention also relates to a device for carrying out such a method.

### BACKGROUND INFORMATION

Many vehicles are equipped with video cameras that optically acquire the surroundings of the vehicle. However, the height of objects, for example curbs, wheel stoppers, speed bumps, or even pavement markings, is difficult to ascertain from a camera image. For autonomous or assisted driving, however, it is important to correctly classify the height of various objects early in order to ensure safe driving.

U.S. Pat. No. 9,725,040 B2 describes a vehicle object detection system with which the height of objects is determined as the vehicle approaches the objects. The vehicle object detection system includes a video camera, a controller and a video display. The optical data acquired via the video camera are transmitted to the controller, which uses this data to determine the height of the object and shows it to the driver on the video display.

Existing algorithms for detecting low objects or pavement markings often use a 3D point cloud that is suitable for determining the dimensions of such objects. However, creating a reliable point cloud often requires a fairly complicated solution.

An object of the present invention is to provide a method for motor vehicles for detecting the height of raised objects with which a simpler ascertainment of the height is possible.

The object may be achieved by a method for motor vehicles for detecting the height of raised objects having features of the present invention. The present invention also provides a device for carrying out such a method having features of the present invention. Preferred embodiments of the present invention are disclosed herein.

### SUMMARY

The present invention relates to a method for motor vehicles for detecting the height of raised objects, using at least one camera with which image information from objects can be optically acquired in at least two different lateral positions of the motor vehicle relative to the object. According to an example embodiment of the present invention, the method includes the step of ascertaining object edge portions of the raised objects in the at least two items of image information. An object edge portion is simply understood to be a part of an overall object edge that exists in reality. The object edge is usually not completely detectable, for example due to irregularities or recognition problems that exist in reality, and is therefore broken down into a plurality of recognized object edge portions.

A raised object is something that has a certain height relative to a plane on which the motor vehicle is traveling. A raised object can be curbs of a sidewalk, wheel stoppers or bumps, for example. Whether the detected object is a raised object is ascertained only at the end of the procedure, however, so that object edge portions are ascertained for non-raised objects as well. The two items of image information are images in which the vehicle has different positions relative to the object in lateral direction. Preferably, however, more than two items of image information are used, which improves the accuracy of the method. To implement the method, the raised object has a maximum height that is less than an installation height of the camera.

The method further includes the step of projecting the object edge portions of the objects from the camera onto a base which is calibrated for the camera. The calibrated base is a known height of the camera above the ground. The calibrated base corresponds to the plane on which the motor vehicle is traveling. The projection is used to map the in reality 3-dimensional surroundings onto a 2-dimensional camera image. This makes it easier to recognize the objects and determine the height.

In a subsequent step, the object edge portions are assigned to different objects and a common object edge line is ascertained. Thus, a relationship between the object edge lines which are recognized only as object edge portions is identified, so that the object edge portions are connected to form an overall object edge line. The object edge line obtained in this way can therefore be assigned to different objects shown in the image.

The method also includes the step of ascertaining lines of sight between the camera and the object edge line projected onto the base in the at least two positions. The line of sight is a line that extends from the camera to the object edge line.

In the next method steps, a point of intersection of the at least two lines of sight of the same objects in the same plane is ascertained and a height of the point of intersection above the calibrated base of the respective object is determined. The plane is selected such that the object edge line is perpendicular to the plane. The object edge line therefore appears only as a point in the plane. This means that only one line of sight in a position in the plane is needed to determine the height of the raised object. The point of intersection of the lines of sight corresponds to the real position of the object edge above the calibrated base. The height above the calibrated base can easily be ascertained using the point of intersection obtained in this way in a 2-dimensional view. By using the method, only three 2-dimensional problems have to be solved, which simplifies the ascertainment of a height of a raised object.

Under ideal conditions, multiple lines of sight obtained from multiple positions all intersect at the same point of intersection. However, measurement inaccuracies can result in deviations between the ascertained points of intersection. According to an example embodiment of the present invention, the formula

$$arg {min}_{P ∈ π} \sum {d}^{2} ( {e}_{i} , P )$$

is used to ascertain a common point of intersection P, in which the deviation d of all ascertained points of intersection of the lines of sight e; is minimal. This makes it possible to nonetheless ascertain a common point of intersection.

According to an example embodiment of the present invention, the assignment of object edge portions to different objects preferably comprises the method step of forming clusters of object edge portions that extend in the same direction. Within the meaning of the present invention, a cluster is understood to be a collection of elements that have the same prespecified attributes. This makes it easier to filter out elements that do not belong to an object, which simplifies the ascertainment of the common object edge line.

According to an example embodiment of the present invention, the next step involves forming clusters relating to the clusters of the object edge portions that extend in the same direction with respect to a vertical distance, so that object edge portions, the vertical distance of which is above a limit value, are assigned to a separate cluster. The vertical distance refers to the respective distance perpendicular to an extension direction between an object edge portion and other object edge portions in the same direction. This distance is verified for all object edge portions and for all clusters. The clusters are thus also distinguished from one another in terms of a vertical distance.

The limit value is preferably selected to be above a typical scattering width of the vertical distance of the object edge portions. Other objects, which do extend parallel to a first object but are offset in terms of distance, can thus be distinguished from one another. This further simplifies the ascertainment of the common object edge line.

According to an example embodiment of the present invention, in a further step, clusters are formed, in which a parallel distance between adjacent object edge portions exceeds a limit value. The limit value is selected in accordance with the typical parallel distances. The parallel distance is a distance between two adjacent object edge portions which extends in the extension direction of the object edge portions, and is thus parallel to the object edge portions. This simplifies and improves the ascertainment of the common object edge and the objects themselves.

In a preferred embodiment of the present invention, clusters that have a number of object edge portions which is less than a limit value are discarded. The limit value is selected according to the application. The limit value is preferably between 1-3 object edge portions. This step filters out an object edge portion identified via a measurement error or an insignificant object edge in order to reduce the computational effort. This step is carried out every time clusters are created. Thus the relevant object edges are calculated.

A distance to the object edge parallel to the base is preferably determined after the height of the object has been determined. The parallel distance corresponds to the horizontal distance between the camera and the object edge. Knowledge of this distance is critical for autonomous driving to improve the safety of autonomous driving.

In an advantageous further development of the present invention, an optical distortion caused by the lens is compensated by means of a camera model before the ascertainment of object edge portions. Distortion occurs in particular at the edges of the lens. This is in particular true for a fisheye lens. This distortion is compensated by the camera model, so that an ideal 2-dimensional image is created. This significantly improves the ascertainment of the height of raised objects.

The object of the present invention may additionally be achieved by a device for motor vehicles for detecting the height of raised objects. According to an example embodiment of the present invention, the device comprises at least one camera with which image information can be acquired and a processing unit with which the method according to the present invention can be carried out. The above-described advantages are substantially achieved using such a device. The camera is preferably a fisheye camera, so that a large portion of the surroundings can be captured.

The above-described method can in particular be computer-implemented, for example, and thus embodied in software. The present invention therefore also relates to a computer program comprising machine-readable instructions, which, when they are executed on one or more processing units, cause the processing unit(s) to carry out the described method.

The present invention similarly also relates to a machine-readable data carrier and/or to a download product comprising the computer program. A download product is a digital product that can be transmitted via a data network, i.e. can be downloaded by a user of the data network, and can, for example, be offered for sale in an online shop for immediate download.

According to an example embodiment of the present invention, a processing unit can moreover be equipped with the computer program, with the machine-readable data carrier or with the download product.

Embodiment examples of the present invention are shown in the figure and explained in more detail in the following description.

### BRIEF DESCRIPTION OF THE DRAWINGS

FIG. 1 shows an image from a camera with drawn in object edge portions.

FIG. 2 shows projection of the object edge portions onto a calibrated base and formation of clusters of object edge portions that extend in the same direction, according to an example embodiment of the present invention.

FIG. 3 shows formation of clusters with respect to a vertical distance, according to an example embodiment of the present invention.

FIG. 4 shows formation of clusters with respect to a parallel distance, according to an example embodiment of the present invention.

FIG. 5 show an illustration of the obtained clusters, according to an example embodiment of the present invention.

FIG. 6 shows ascertainment of a line of sight between the camera and an object edge projected onto the base at a time t, according to an example embodiment of the present invention.

FIG. 7 shows ascertainment of a line of sight between the camera and an object edge projected onto the base at a time t+1 and ascertainment of the point of intersection of the lines.

### DETAILED DESCRIPTION OF EXAMPLE EMBODIMENTS

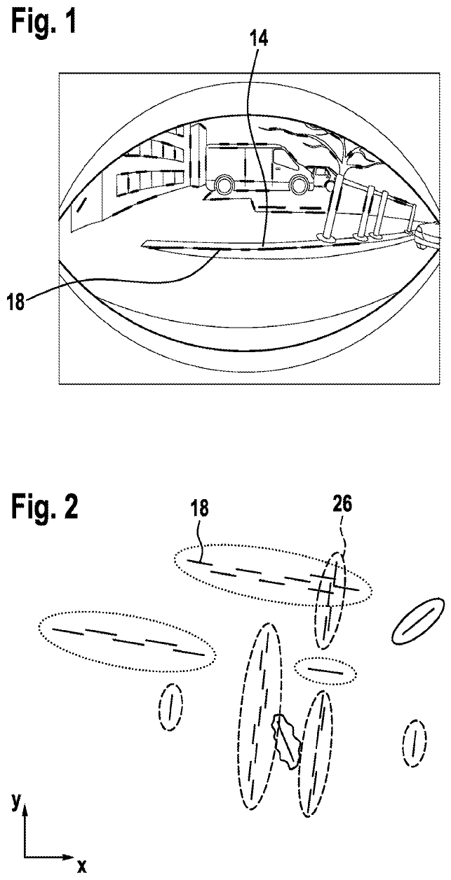

FIG. 1 shows an image from a camera 10 (see FIG. 6) of a motor vehicle. A variety of raised objects 14, such as sidewalk edges, etc., can be seen in this image. The edges shown in this image are recognized in part by means of the method and marked in the image with object edge portions 18.

The object edge portions 18 recognized in the image are projected in a next step onto a base 22 calibrated for the camera 10 (see also FIG. 6) as shown in FIG. 2. The calibrated base 22 is ascertained based on the known installation height H (see FIG. 6) of the camera 10. Clusters 26 of object edge portions 18 that extend in the same direction are formed as well. In the shown embodiment example, a total of four different clusters 26 of object edge portions 18 are formed and are characterized by different outlines. Two of these clusters 26 include only a single object edge portion 18, so that these clusters 26 are discarded in a next step.

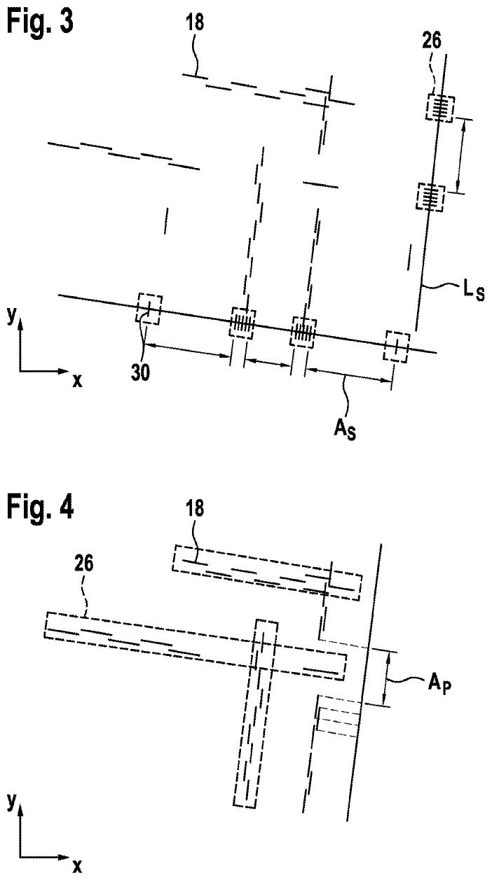

FIG. 3 shows how clusters 26 are formed with respect to a vertical distance A_{S}. For this purpose, the object edge portions 18 can be projected onto a line L_{S} which is perpendicular to the orientation of the cluster 26. To form the clusters 26, the vertical distance A_{S} between two adjacent projected lines 30 is then checked to see if it exceeds a limit value. If this is the case, a new cluster 26 is formed. In the newly formed clusters 26, two clusters 26 include only a single object edge portion 18. Since this number is below a prespecified limit value, these clusters 26 are discarded in a next step.

FIG. 4 shows how clusters 26 are formed with respect to a parallel distance A_{P}. In this figure, the parallel distance A_{P} is determined using a cluster 26 as an example. All of the object edge portions 18 are examined here in terms of their parallel distance A_{P} to an adjacent object edge portion 18. In the shown figure, the parallel distance A_{P} between two adjacent object edge portions 18 is examined merely as an example. The examination is to check whether the parallel distance A_{P} is below a limit value. If the distance A_{P} is above the limit value, the adjacent object edge portion 18 is assigned to a new cluster 26. Clusters 26 that only have a number of object edge portions 18 below a limit value are discarded in a next step in this step as well. In FIG. 4, this is the case for an object edge portion 18 disposed further away.

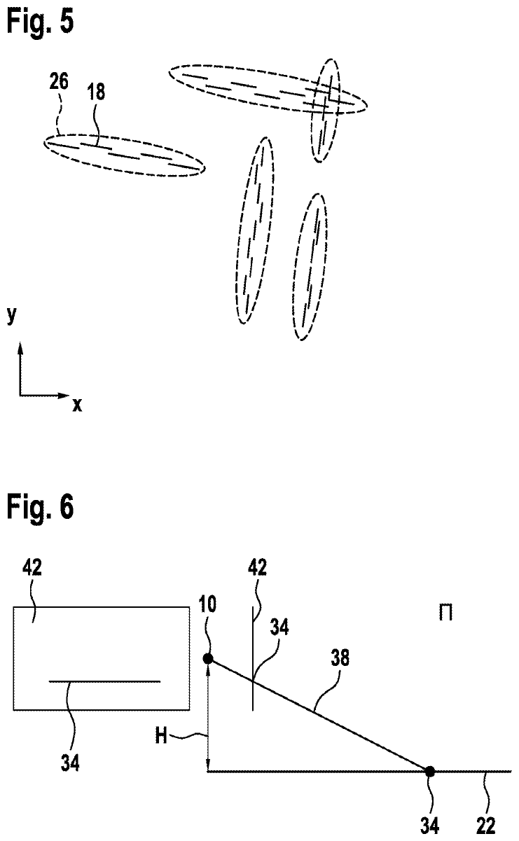

FIG. 5 shows the clusters 26 formed from the preceding steps. Each cluster 26 is enclosed by a frame. An object edge line 34 shown in FIG. 6 is then created from the object edge portions 18 disposed in a cluster 26.

FIG. 6 shows the ascertainment of a line of sight 38 between the camera 10 and an object edge line 34 projected onto the base 22 at a time t. This shows an image 42 with a previously ascertained object edge line 34. Based on the focal length of the camera 10 and the position of the object edge line 34 in the image 42, a line of sight 38 between the camera 10 and the object edge line 34 projected on the base is ascertained in a plane Π. The object edge line 34 is oriented perpendicular to the plane Π, so that the object edge line 34 is depicted as a point.

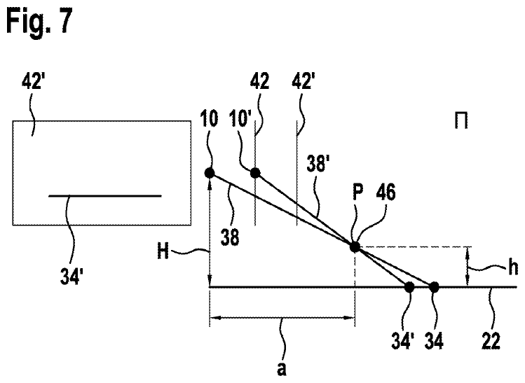

FIG. 7 shows an ascertainment of a line of sight 38′ between the camera 10 and an object edge line 34′ projected onto the base at a time t+1. The step of FIG. 6 is also carried out in another position of the motor vehicle. This results in a line of sight 38 at t and a line of sight 38′ at t+1. By ascertaining a point of intersection P between the line of sight 38 at t and the line of sight 38′ at t+1, the actual position of the object edge 46 in the side view is ascertained. This can in turn be used to ascertain the height h of the object edge 46 above the calibrated base 22. The horizontal distance a between the camera 10 and the object edge 46 is determined as well for this purpose.

The use of a plurality of such lines of sight 38 produced from a plurality of lateral positions relative to the object edge line 34 makes it possible to increase the accuracy of the ascertainment of the point of intersection P. Ideally, all of the lines of sight then intersect at the point of intersection P. However, measurement inaccuracies can result in deviations between the ascertained points of intersection. The formula

$$arg {min}_{P ∈ π} \sum {d}^{2} ( {e}_{i} , P )$$

is used to ascertain a common point of intersection P in the plane Δ. In which case, eᵢ in the formula indicates the lines of sight 38. The variable d corresponds to the respective distance of the line of sight 38 from the point P.

1-9. (canceled)

10. A method for a motor vehicle for detecting a height of raised objects using at least one camera with which image information from objects can be optically acquired in at least two different lateral positions of the motor vehicle relative to the object, the method comprising the following steps:
ascertaining object edge portions of the objects in at least two items of image information;
projecting the object edge portions of the objects from the camera onto a base which is calibrated for the camera, wherein the projection is used to map the object edge portions of the objects of 3-dimensional surroundings onto a 2-dimensional camera image and a calibrated base is obtained from a known installation height of the camera above the ground;
assigning the object edge portions to different objects and ascertaining a common object edge line, wherein the assigning includes:
forming clusters of object edge portions that extend in the same direction,
forming clusters relating to the clusters of the object edge portions that extend in the same direction with respect to a vertical distance, so that those of the object edge portions, the vertical distance of which is above a limit value, are assigned to a separate cluster, and
forming clusters when a parallel distance between adjacent object edge portions exceeds a limit value, wherein the ascertaining of the common object edge line includes forming an object edge line from the object edge portions arranged in a cluster,
ascertaining lines of sight between the camera and the object edge line projected onto the calibrated base in the at least two positions, wherein each line of sight between the camera and the object edge line projected onto the calibrated base is ascertained based on the position of the common object edge line in the 2-dimensional camera image and a focal length of the camera in a plane oriented perpendicular to the object edge line;
ascertaining a point of intersection of the at least two lines of sight of the same objects in the same plane; and
determining a height of the point of intersection above the calibrated base of a respective object.

11. The method according to claim 10, wherein those of the clusters that have a number of object edge portions which is less than a limit value are discarded.

12. The method according to claim 10, wherein a distance to the object edge parallel to the base is determined after the height of the object has been determined.

13. The method according to claim 10, wherein an optical distortion caused by a lens is compensated using a camera model before the ascertainment of the object edge portions.

14. A device for a motor vehicle for detecting a height of raised objects, comprising:
at least one camera with which image information can be acquired; and
a processing unit configured to:
ascertain object edge portions of the objects in at least two items of image information;
project the object edge portions of the objects from the camera onto a base which is calibrated for the camera, wherein the projection is used to map the object edge portions of the objects of 3-dimensional surroundings onto a 2-dimensional camera image and a calibrated base is obtained from a known installation height of the camera above the ground;
assign the object edge portions to different objects and ascertaining a common object edge line, wherein the assigning includes:
forming clusters of object edge portions that extend in the same direction,
forming clusters relating to the clusters of the object edge portions that extend in the same direction with respect to a vertical distance, so that those of the object edge portions, the vertical distance of which is above a limit value, are assigned to a separate cluster, and
forming clusters when a parallel distance between adjacent object edge portions exceeds a limit value, wherein the ascertaining of the common object edge line includes forming an object edge line from the object edge portions arranged in a cluster,
ascertain lines of sight between the camera and the object edge line projected onto the calibrated base in the at least two positions, wherein each line of sight between the camera and the object edge line projected onto the calibrated base is ascertained based on the position of the common object edge line in the 2-dimensional camera image and a focal length of the camera in a plane oriented perpendicular to the object edge line;
ascertain a point of intersection of the at least two lines of sight of the same objects in the same plane; and
determine a height of the point of intersection above the calibrated base of a respective object.

15. A machine-readable data carrier on which is stored a computer program for a motor vehicle for detecting a height of raised objects using at least one camera with which image information from objects can be optically acquired in at least two different lateral positions of the motor vehicle relative to the object, the computer program, when executed by one or more processors, causing the one or more processors to perform the following steps:
ascertaining object edge portions of the objects in at least two items of image information;
projecting the object edge portions of the objects from the camera onto a base which is calibrated for the camera, wherein the projection is used to map the object edge portions of the objects of 3-dimensional surroundings onto a 2-dimensional camera image and a calibrated base is obtained from a known installation height of the camera above the ground;
assigning the object edge portions to different objects and ascertaining a common object edge line, wherein the assigning includes:
forming clusters of object edge portions that extend in the same direction,
forming clusters relating to the clusters of the object edge portions that extend in the same direction with respect to a vertical distance, so that those of the object edge portions, the vertical distance of which is above a limit value, are assigned to a separate cluster, and
forming clusters when a parallel distance between adjacent object edge portions exceeds a limit value, wherein the ascertaining of the common object edge line includes forming an object edge line from the object edge portions arranged in a cluster,
ascertaining lines of sight between the camera and the object edge line projected onto the calibrated base in the at least two positions, wherein each line of sight between the camera and the object edge line projected onto the calibrated base is ascertained based on the position of the common object edge line in the 2-dimensional camera image and a focal length of the camera in a plane oriented perpendicular to the object edge line;
ascertaining a point of intersection of the at least two lines of sight of the same objects in the same plane; and
determining a height of the point of intersection above the calibrated base of a respective object.

16. A processing unit, comprising:
a machine-readable data carrier on which is stored a computer program for a motor vehicle for detecting a height of raised objects using at least one camera with which image information from objects can be optically acquired in at least two different lateral positions of the motor vehicle relative to the object, the computer program, when executed by one or more processors, causing the one or more processors to perform the following steps:
ascertaining object edge portions of the objects in at least two items of image information;
projecting the object edge portions of the objects from the camera onto a base which is calibrated for the camera, wherein the projection is used to map the object edge portions of the objects of 3-dimensional surroundings onto a 2-dimensional camera image and a calibrated base is obtained from a known installation height of the camera above the ground;
assigning the object edge portions to different objects and ascertaining a common object edge line, wherein the assigning includes:
forming clusters of object edge portions that extend in the same direction,
forming clusters relating to the clusters of the object edge portions that extend in the same direction with respect to a vertical distance, so that those of the object edge portions, the vertical distance of which is above a limit value, are assigned to a separate cluster, and
forming clusters when a parallel distance between adjacent object edge portions exceeds a limit value, wherein the ascertaining of the common object edge line includes forming an object edge line from the object edge portions arranged in a cluster,
ascertaining lines of sight between the camera and the object edge line projected onto the calibrated base in the at least two positions, wherein each line of sight between the camera and the object edge line projected onto the calibrated base is ascertained based on the position of the common object edge line in the 2-dimensional camera image and a focal length of the camera in a plane oriented perpendicular to the object edge line;
ascertaining a point of intersection of the at least two lines of sight of the same objects in the same plane; and
determining a height of the point of intersection above the calibrated base of a respective object.
